(19) United States
(12) Patent Application Publication
(10) Pub. No.: US 2025/0075773 A1
(43) Pub. Date: Mar. 6, 2025

(54) PLANETARY WHEEL END

(71) Applicant: Schaeffler Technologies AG & Co. KG, Herzogenaurach (DE)

(72) Inventors: Franklin May, Puebla (MX); Angel Salvador Flores, Puebla (MX); David Burky, Massillon, OH (US); Ayyalraju Satyaseelan, Wooster, OH (US)

(73) Assignee: Schaeffler Technologies AG & Co. KG, Herzogenaurach (DE)

(21) Appl. No.: 18/411,572

(22) Filed: Jan. 12, 2024

Related U.S. Application Data
(60) Provisional application No. 63/536,220, filed on Sep. 1, 2023.

(51) Int. Cl. F16H 1/28; B60B 27/00; B60K 17/04; F16H 57/08

(52) U.S. Cl. CPC F16H 1/28; B60B 27/0047; B60K 17/046; F16H 57/082; B60B 2900/111; B60B 2900/112; B60B 2900/113; B60B 2900/114; B60B 2900/321; B60B 2900/511; B60B 2900/541; B60B 2900/572; F16H 2057/085

(57) ABSTRACT

A planetary wheel end includes a planetary gear set, a rotatable axle shaft, a rotationally fixed axle tube surrounding at least a portion of the axle shaft, and a planetary gear carrier arranged for fixing to a wheel. The planetary gear set includes a radially inner sun gear, a radially outer ring gear and a plurality of planet gears drivingly engaged with the sun gear and the ring gear. The axle shaft is rotationally fixed to the sun gear and the axle tube includes a spindle rotationally fixed to the ring gear. The planetary gear carrier includes a plurality of planetary shafts and each one of the planet gears is rotatable about a respective one of the planetary shafts. In an example embodiment, each one of the plurality of planet gears has a respective radial needle bearing disposed on the respective one of the plurality of planetary shafts.

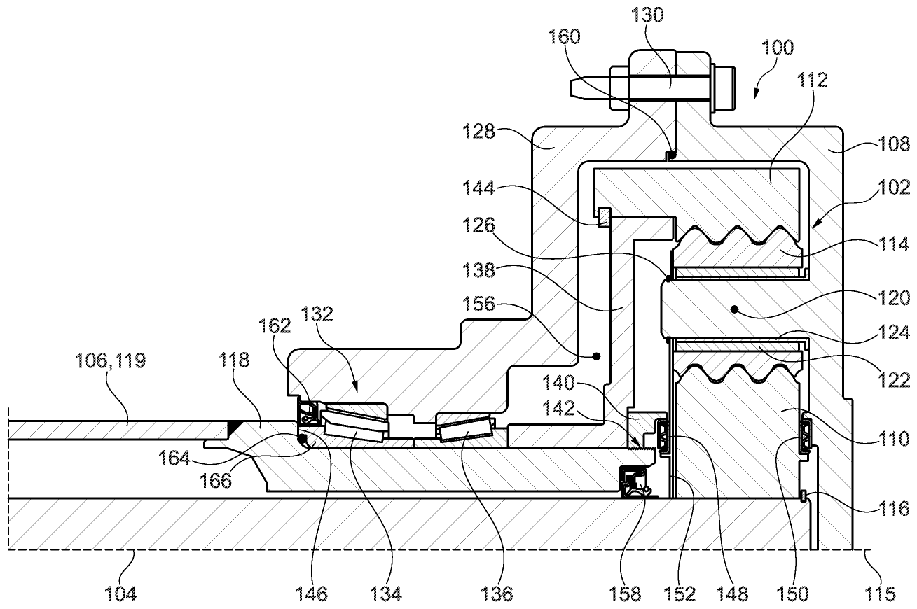

### CROSS-REFERENCE TO RELATED APPLICATIONS

This application claims the benefit of U.S. Provisional Patent Application No. 63/536,220, filed Sep. 1, 2023, the disclosure of which is incorporated in its entirety by reference herein.

### TECHNICAL FIELD

The present disclosure relates generally to a wheel end for a vehicle axle, and more specifically to a planetary wheel end.

### BACKGROUND

Outer planetary axles for motor vehicles are known. One example is shown and described in United States Patent Application Publication No. 2023/0134790 titled PLUG-IN SHAFT ARRANGEMENT AND HUB-REDUCTION AXLE FOR A MOTOR VEHICLE to Waim et al.

### SUMMARY

Example embodiments broadly comprise a planetary wheel end including a planetary gear set, a rotatable axle shaft, a rotationally fixed axle tube surrounding at least a portion of the axle shaft, and a planetary gear carrier arranged for fixing to a wheel. The planetary gear set includes a radially inner sun gear, a radially outer ring gear and a plurality of planet gears drivingly engaged with the sun gear and the ring gear. The rotatable axle shaft is rotationally fixed to the sun gear and the axle tube includes a spindle rotationally fixed to the ring gear. The planetary gear carrier includes a plurality of planetary shafts and each one of the plurality of planet gears is rotatable about a respective one of the plurality of planetary shafts. In an example embodiment, each one of the plurality of planet gears has a respective radial needle bearing disposed on the respective one of the plurality of planetary shafts. In an example embodiment, each one of the plurality of planetary shafts has a hardened sleeve. In an example embodiment, each one of the plurality of planet gears is secured on the respective one of the plurality of planetary shafts by a respective snap ring.

In some example embodiments, the planetary wheel end also includes a wheel hub fastened to the planetary gear carrier and a roller bearing for rotationally supporting the wheel hub on the spindle. In an example embodiment, the roller bearing has a pair of tapered roller bearings. In some example embodiments, the planetary wheel end also includes a ring gear carrier rotationally fixed to the spindle and to the ring gear. In some example embodiments, the planetary wheel end also includes a spindle nut and the ring gear carrier is axially secured to the spindle by the spindle nut threaded onto the spindle. In an example embodiment, the spindle has a radial wall and the roller bearing is axially secured between the radial wall and the ring gear carrier.

In some example embodiments, the planetary wheel end also includes a pair of thrust bearings disposed on opposite axial sides of the sun gear. In an example embodiment, the planetary wheel end also includes a spindle nut threaded onto the spindle. One of the pair of thrust bearings is axially supported by the spindle nut and the other one of the pair of thrust bearings is axially supported by the planetary gear carrier.

In some example embodiments, the planetary wheel end also includes a wheel hub fastened to the planetary gear carrier. The spindle, the wheel hub, the axle shaft and the planetary gear carrier form respective portions of a sealed chamber surrounding the planetary gear set. In an example embodiment, the planetary wheel end also includes a first seal that seals the spindle directly to the axle shaft. In an example embodiment, the planetary wheel end also includes a second seal that seals the wheel hub to the planetary gear carrier. In an example embodiment, the planetary wheel end also includes a roller bearing for supporting the wheel hub on the spindle, a third seal that seals the wheel hub to the roller bearing, and a fourth seal that seals the roller bearing to the spindle.

### BRIEF DESCRIPTION OF THE DRAWINGS

The single FIGURE illustrates a top-half cross-sectional view of a planetary wheel end according to an example aspect of the present disclosure.

### DETAILED DESCRIPTION

Embodiments of the present disclosure are described herein. It should be appreciated that like drawing numbers appearing in different drawing views identify identical, or functionally similar, structural elements. Also, it is to be understood that the disclosed embodiments are merely examples and other embodiments can take various and alternative forms. The FIGURES are not necessarily to scale; some features could be exaggerated or minimized to show details of particular components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the FIGURES can be combined with features illustrated in one or more other FIGURES to produce embodiments that are not explicitly illustrated or described. The combinations of features illustrated provide representative embodiments for typical applications. Various combinations and modifications of the features consistent with the teachings of this disclosure, however, could be desired for particular applications or implementations.

The terminology used herein is for the purpose of describing particular aspects only, and is not intended to limit the scope of the present disclosure. Unless defined otherwise, all technical and scientific terms used herein have the same meaning as commonly understood to one of ordinary skill in the art to which this disclosure belongs. Although any methods, devices or materials similar or equivalent to those described herein can be used in the practice or testing of the disclosure, the following example methods, devices, and materials are now described.

The following description is made with reference to the single FIGURE. The single FIGURE illustrates a top-half cross-sectional view of planetary wheel end 100 according to an example aspect of the present disclosure. Planetary wheel end 100 includes planetary gear set 102, rotatable axle shaft 104, rotationally fixed axle tube 106 surrounding at least a portion of the axle shaft, and planetary gear carrier 108. The planetary gear set includes radially inner sun gear 110, radially outer ring gear 112 and planet gears 114 drivingly engaged with the sun gear and the ring gear. By drivingly engaged, we mean that the gears include teeth (e.g., straight cut gear teeth or helical gear teeth) that are intermeshed so that rotation of one of the gears rotates the other gears. Although only one planetary gear is shown in the FIGURE, several planetary gears (e.g., 3 or more) may be circumferentially distributed about central axis 115, for example.

Axle shaft 104 is rotationally fixed to the sun gear. For example, the shaft and the gear may be connected with a spline connection with the gear axially secured to the shaft by snap ring 116, for example. The axle tube may be attached to a differential assembly or another portion of an axle assembly (e.g., e-axle) and surrounds a portion of the axle shaft as can be seen in the single FIGURE, for example. In other words, the axle shaft is concentric with and extends inside the axle tube. Axle tube 106 includes spindle 118 rotationally fixed to the ring gear as described in more detail below. Spindle 118 may be a separate component fixed to tube portion 119 of the axle tube (e.g., via welding as shown in the FIGURE) or may be integrally formed with tube portion 119. The planetary gear carrier is arranged for fixing to a wheel via wheel studs (not shown) secured to the planetary gear carrier, for example and includes planetary shafts 120. In the embodiment shown, the planetary gear carrier is a cast and machined part and the planetary shafts are integrally cast with the planetary gear carrier. Other embodiments (not shown) may include separate planetary shafts secured to the planetary gear carrier by press fitting, staking, welding, or adhesives, for example. Each one of planet gears 114 is rotatable about a respective one of planetary shafts 120.

In the embodiment shown, the planet gear includes radial needle bearing 122 disposed on the planetary shaft. In the case of multiple planetary gears, each planetary gear includes a respective needle bearing. Planetary shaft 120 includes hardened sleeve 124 to provide a rolling surface for the radial needle bearing. The planet gear is secured on the planetary shaft by snap ring 126.

Planetary wheel end 100 also includes wheel hub 128 fastened to the planetary gear carrier (e.g., via bolts 130) and roller bearing 132 for rotationally supporting the wheel hub on the spindle. In the example embodiment shown in the FIGURE, the roller bearing includes tapered roller bearings 134 and 136. Planetary wheel end 100 also includes ring gear carrier 138 rotationally fixed to the spindle and to the ring gear via respective spline connections, for example, and spindle nut 140. The ring gear carrier is axially secured to the spindle by the spindle nut threaded onto the spindle. That is, the ring gear carrier is slid onto the spindle to engage the spline connection, rotationally fixing the two components together, and the spindle nut is threaded onto threaded end 142 of the spindle to retain the ring gear carrier on the spindle. Snap ring 144 axially secures the ring gear carrier to the ring gear, similar to the spindle nut described above. Spindle 118 includes radial wall 146 and roller bearing 132 is axially secured between the radial wall and the ring gear carrier.

Planetary wheel end 100 also includes thrust bearings 148 and 150 disposed on opposite axial sides of the sun gear. In the embodiment shown, the thrust bearings are thrust needle bearings. As shown in the FIGURE, thrust bearing 148 is axially supported by the spindle nut and thrust bearing 150 is axially supported by the planetary gear carrier. Thrust bearing 148 is radially supported on a radial outside by the spindle nut and on a radial inside by planetary side plate 152 secured to the planetary shaft by snap ring 126. Similarly, thrust bearing 150 is radially supported on a radial inside by the sun gear and on a radial outside by the planetary gear carrier.

The spindle, the wheel hub, the axle shaft and the planetary gear carrier form respective portions of sealed chamber 156 surrounding the planetary gear set. That is, the planetary gear set is disposed in a sealed chamber containing a lubricating fluid that is separate from other lubricating or cooling fluids for the remaining axle components (e.g., differential, electric motor, etc.) The planetary wheel end also includes seal 158 that seals the spindle directly to the axle shaft, and seal 160 that seals the wheel hub to the planetary gear carrier. In the embodiment shown, seal 158 is a lip seal and seal 160 is an o-ring seal, although other seal types are possible. The planetary wheel end also includes seal 162 that seals the wheel hub to roller bearing 132, and seal 164 that seals the roller bearing to the spindle. That is, tapered roller bearing 134 includes extended inner race 166 and seals 162 and 164 are disposed on a radial outside and inside, respectively, of the extended portion of the inner race. As shown in the FIGURE, seal 162 is a lip seal (similar to seal 158 described above) and seal 164 is an o-ring seal (similar to seal 160 described above).

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes can include, but are not limited to cost, strength, durability, life cycle cost, marketability, appearance, packaging, size, serviceability, weight, manufacturability, case of assembly, etc. As such, to the extent any embodiments are described as less desirable than other embodiments or prior art implementations with respect to one or more characteristics, these embodiments are not outside the scope of the disclosure and can be desirable for particular applications.

### REFERENCE NUMERALS

100 Planetary wheel end
102 Planetary gear set
104 Axle shaft
106 Axle tube
108 Planetary gear carrier
110 Sun gear
112 Ring gear
114 Planet gears
115 Central axis
116 Snap ring (axle shaft)
118 Spindle
119 Tube portion (axle tube)
120 Planetary shafts
122 Radial needle bearing
124 Hardened sleeve
126 Snap ring (planetary shaft)
128 Wheel hub
130 Bolts (wheel hub to planetary gear carrier)
132 Roller bearing
134 Tapered roller bearing
136 Tapered roller bearing
138 Ring gear carrier
140 Spindle nut
142 Threaded end (spindle)
144 Snap ring (ring gear carrier to ring gear)
146 Radial wall (spindle)
148 Thrust bearing
150 Thrust bearing
152 Planetary side plate
156 Sealed chamber
158 Seal (first, spindle to axle shaft)
160 Seal (second, wheel hub to planetary gear carrier)
162 Seal (third, wheel hub to roller bearing)
164 Seal (fourth, roller bearing to spindle)
166 Extended inner race (tapered roller bearing 134)

What is claimed is:

1. A planetary wheel end, comprising:
a planetary gear set comprising:
a radially inner sun gear;
a radially outer ring gear; and
a plurality of planet gears drivingly engaged with the sun gear and the ring gear;
a rotatable axle shaft rotationally fixed to the sun gear;
a rotationally fixed axle tube surrounding at least a portion of the axle shaft, the axle tube comprising a spindle rotationally fixed to the ring gear; and
a planetary gear carrier arranged for fixing to a wheel, the planetary gear carrier comprising a plurality of planetary shafts and each one of the plurality of planet gears is rotatable about a respective one of the plurality of planetary shafts.

2. The planetary wheel end of claim 1 wherein each one of the plurality of planet gears comprises a respective radial needle bearing disposed on the respective one of the plurality of planetary shafts.

3. The planetary wheel end of claim 1 wherein each one of the plurality of planetary shafts comprises a hardened sleeve.

4. The planetary wheel end of claim 1 wherein each one of the plurality of planet gears is secured on the respective one of the plurality of planetary shafts by a respective snap ring.

5. The planetary wheel end of claim 1 further comprising:
a wheel hub fastened to the planetary gear carrier; and
a roller bearing for rotationally supporting the wheel hub on the spindle.

6. The planetary wheel end of claim 5 wherein the roller bearing comprises a pair of tapered roller bearings.

7. The planetary wheel end of claim 5 further comprising a ring gear carrier rotationally fixed to the spindle and to the ring gear.

8. The planetary wheel end of claim 7 further comprising a spindle nut, wherein the ring gear carrier is axially secured to the spindle by the spindle nut threaded onto the spindle.

9. The planetary wheel end of claim 8 wherein:
the spindle comprises a radial wall; and
the roller bearing is axially secured between the radial wall and the ring gear carrier.

10. The planetary wheel end of claim 1 further comprising a pair of thrust bearings disposed on opposite axial sides of the sun gear.

11. The planetary wheel end of claim 10 further comprising a spindle nut threaded onto the spindle, wherein one of the pair of thrust bearings is axially supported by the spindle nut and the other one of the pair of thrust bearings is axially supported by the planetary gear carrier.

12. The planetary wheel end of claim 1 further comprising a wheel hub fastened to the planetary gear carrier, wherein the spindle, the wheel hub, the axle shaft and the planetary gear carrier form respective portions of a sealed chamber surrounding the planetary gear set.

13. The planetary wheel end of claim 12 further comprising a first seal that seals the spindle directly to the axle shaft.

14. The planetary wheel end of claim 12 further comprising a second seal that seals the wheel hub to the planetary gear carrier.

15. The planetary wheel end of claim 12 further comprising:
a roller bearing for supporting the wheel hub on the spindle;
a third seal that seals the wheel hub to the roller bearing; and
a fourth seal that seals the roller bearing to the spindle.
